(19) United States
(12) Patent Application Publication
(10) Pub. No.: US 2025/0372069 A1
(43) Pub. Date: Dec. 4, 2025

(54) AUDIO CONTROL DEVICE AND AUDIO CONTROL PROGRAM

(71) Applicant: AlphaTheta Corporation, Yokohama-shi, Kanagawa (JP)

(72) Inventors: Kenta Sagawa, Yokohama-shi, Kanagawa (JP); Nao Takagi, Yokohama-shi, Kanagawa (JP); Takashi Mashita, Yokohama-shi, Kanagawa (JP)

(21) Appl. No.: 18/871,010

(22) PCT Filed: Jul. 29, 2022
(86) PCT No.: PCT/JP2022/029353

§ 371 Date: Dec. 2, 2024

(51) Int. Cl. G10H 1/00; G10H 1/46

(52) U.S. Cl. CPC G10H 1/0091; G10H 1/0025; G10H 1/46; G10H 2210/076; G10H 2210/125; G10H 2210/385; G10H 2240/325

(57) ABSTRACT

A sound control device configured to mix a first music piece and a second music piece includes: a comparing section configured compare a BPM of the first music piece and a BPM of the second music piece; and an effect selecting section configured to select a sound effect according to a result of the comparison.

### TECHNICAL FIELD

The present invention relates to a sound control device and a sound control program.

### BACKGROUND ART

A sound device that mixes and outputs a plurality of music pieces has been known (for instance, see Patent Literature 1).

A sound device described in Patent Literature 1, which is a so-called mixer, mixes music pieces fed from a music piece feeding device such as a PC and a smartphone and outputs an audio signal corresponding to the mixed music piece to a speaker.

The sound device includes operators such as a first channel fader, a second channel fader, and a cross fader. The first channel fader and the second channel fader each include an operator movable up and down, and the cross fader includes an operator movable right and left. The sound device adjusts, in response to the operation on the first channel fader, a sound volume of a music piece input to a first channel from the music piece feeding device and adjusts, in response to the operation on the second channel fader, a sound volume of a music piece input to a second channel from the music piece feeding device. The sound device also adjusts, in response to the operation on the cross fader, a balance between the sound volume of the first channel and the sound volume of the second channel. For instance, a proportion of the first channel in a sound volume to be output from the sound device increases as the operator of the cross fader moves leftward, whereas a proportion of the second channel in the sound volume to be output from the sound device increases as the operator moves rightward.

### CITATION LIST

### Patent Literature(s)

Patent Literature 1: International Publication No. WO 2022/054263

### SUMMARY OF THE INVENTION

### Problem(s) to be Solved by the Invention

Consider mixing between the music piece input to the first channel and the music piece input to the second channel. If an inexperienced user such as a beginner operates the sound device, it is difficult to mix the music piece of the first channel and the music piece of the second channel without a feeling of strangeness.

### Means for Solving the Problem(s)

According to a first aspect of the invention, there is provided a sound control device configured to mix a first music piece and a second music piece and including: a comparing section configured to compare a BPM of the first music piece and a BPM of the second music piece; and an effect selecting section configured to select a sound effect according to a result of the comparison.

According to a second aspect of the invention, there is provided a sound control device configured to mix a first music piece and a second music piece and including: a playback controlling section configured to fade out the first music piece when a switching operation to switch a music piece to be output from the first music piece to the second music piece is completed within a predetermined period of time since the switching operation is started; and an effect adding section configured to add, out of at least one sound effect, a synchronization effect that is synched with BPM of the second music piece to the first music piece.

According to a third aspect of the invention, there is provided a sound control device configured to mix a first music piece and a second music piece, the first music piece including a first vocal part, the second music piece including a second vocal part, the sound control device including a composition switching section configured to perform, in response to an operation to decrease a sound volume of the first music piece and increase a sound volume of the second music piece at a speed equal to or less than a predetermined speed, switching between the first vocal part and the second vocal part in a case where a difference between a BPM of the first music piece and a BPM of the second music piece is equal to or less than a predetermined value.

According to a fourth aspect of the invention, there is provided a sound control program configured to be recorded in a computer-readable manner, the sound control program being configured to cause a computer to function as the sound control device according to any one of the first to the third aspects.

### BRIEF DESCRIPTION OF DRAWINGS

FIG. 1 schematically illustrates a configuration of a sound control device of an exemplary embodiment.

FIG. 2 is a block diagram of a controller of the exemplary embodiment.

FIG. 3 illustrates a change in sound volume of a first music piece as a whole and a change in sound volume of a second music piece as a whole caused by operating a cross fader in a normal mode in the exemplary embodiment.

FIG. 4 is a flowchart for a mixing assist process performed in an assist mode of the exemplary embodiment.

### DESCRIPTION OF EMBODIMENT(S)

Referring to the drawings, an exemplary embodiment of the invention will be described below.

### Configuration of Sound Control Device

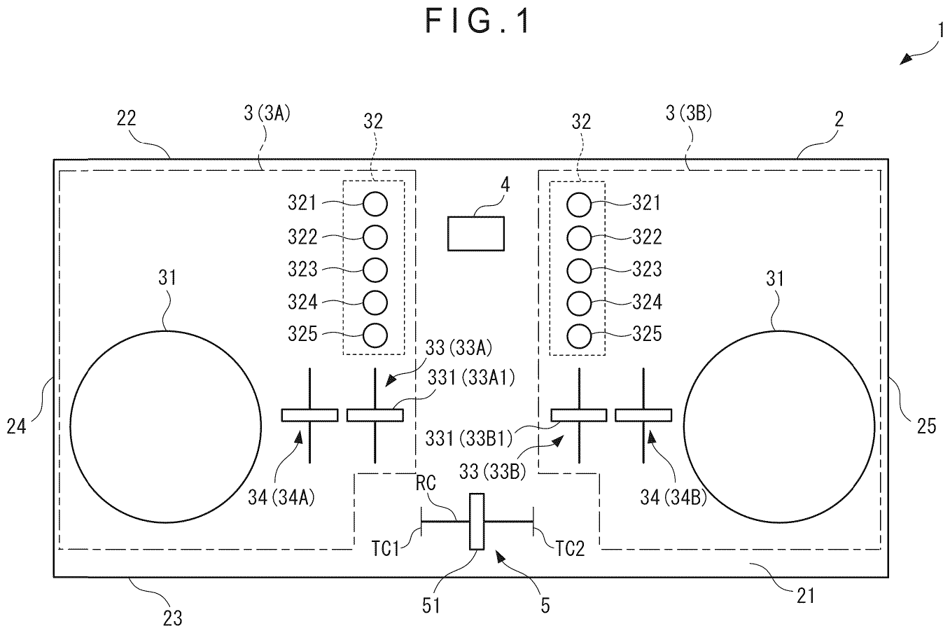

FIG. 1 schematically illustrates a configuration of a sound control device 1 according to the exemplary embodiment.

The sound control device 1 according to the exemplary embodiment mixes a plurality of music pieces. Specifically, the sound control device 1 mixes a first music piece loaded on a first channel and a second music piece loaded on a second channel and outputs an audio signal corresponding to a mixed music piece.

Although it will be described later in detail, the sound control device 1 may be characterized by including a normal mode for mixing the first music piece and the second music piece in response to an operation on an operator and an assist mode for assisting the mixing of the first music piece and the second music piece.

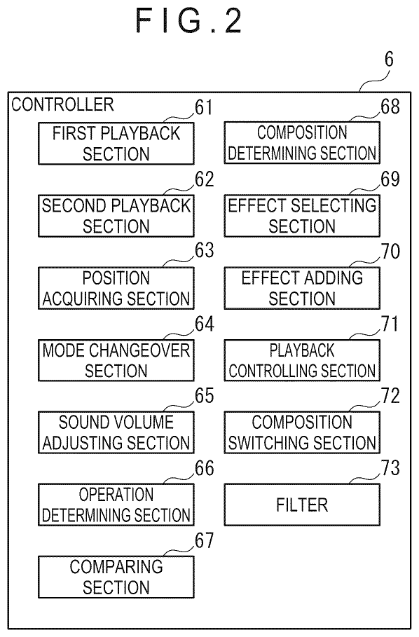

The sound control device 1 includes a casing 2, two channel operation units 3, a mode changeover switch 4, and a cross fader 5, as illustrated in FIG. 1. Although not illustrated in FIG. 1, the sound control device 1 further includes a controller 6 (see FIG. 2) that controls the operation of the sound control device 1.

### Configuration of Casing

The casing 2, which has a substantially rectangular parallelepiped shape, contains the controller 6 therein. The casing 2 has a top surface 21, an upper surface 22, a lower surface 23, a left side surface 24, a right side surface 25, and a non-illustrated bottom surface.

The two channel operation units 3, the mode changeover switch 4, and the cross fader 5 are disposed on the top surface 21.

### Configuration of Channel Operation Unit

The two channel operation units 3 perform operation for playback states of music pieces loaded on the respective channels. The two channel operation units 3 include a first channel operation unit 3A that performs operation for the playback state of the first music piece loaded on the first channel and a second channel operation unit 3B that performs operation for the playback state of the second music piece loaded on the second channel.

Each of the channel operation units 3A and 3B includes a jog dial 31, an equalizer adjuster 32, a channel fader 33, and a tempo slider 34.

The jog dial 31, which is rotatably provided on the top surface 21, includes a dial used to adjust a playback direction and a playback speed of a music piece being played. A user performs a scratch operation unique to DJ performance by changing a rotation direction and a rotation speed of the jog dial 31 in combination.

The equalizer adjuster 32 performs an equalizer adjusting process for the corresponding channel. Specifically, the equalizer adjuster 32 of the first channel operation unit 3A performs an equalizer adjusting process for the first channel and the equalizer adjuster 32 of the second channel operation unit 3B performs an equalizer adjusting process for the second channel. Each of the equalizer adjusters 32 includes a level adjuster 321, a high-frequency band adjuster 322, a medium-frequency band adjuster 323, a low-frequency band adjuster 324, and an effect adjuster 325.

Each of the level adjuster 321, the high-frequency band adjuster 322, the medium-frequency band adjuster 323, the low-frequency band adjuster 324, and the effect adjuster 325 is in a form of a rotary encoder including a knob rotatable in one direction and in the other direction around a rotation axis.

The level adjuster 321 adjusts an input level of a music piece input to the corresponding channel.

The high-frequency band adjuster 322 adjusts a sound volume level of a high-frequency band of the music piece input to the corresponding channel. The high-frequency band is, for instance, a frequency band higher than or equal to 4649 Hz.

The medium-frequency band adjuster 323 adjusts a sound volume level of a medium-frequency band of the music piece input to the corresponding channel. The medium-frequency band is, for instance, a frequency band higher than 284 Hz and lower than 4649 Hz.

The low-frequency band adjuster 324 adjusts a maximum sound volume level of a low-frequency band of the music piece input to the corresponding channel. The low-frequency band is, for instance, a frequency band lower than or equal to 284 Hz.

The effect adjuster 325 is an operator that adjusts an effect amount of an effect set in the corresponding channel operation unit 3.

The channel fader 33 is an operator that adjusts the sound volume to be output from the corresponding channel operation unit 3 and, consequently, the sound control device 1. Specifically, the channel fader 33 of the first channel operation unit 3A, which is a first channel fader 33A, adjusts the sound volume to be output from the sound control device 1. The channel fader 33 of the second channel operation unit 3B, which is a second channel fader 33B, adjusts the sound volume to be output from the sound control device 1.

Each of the channel faders 33 includes a fader operator 331 slidable up and down. When the fader operator 331 is operated to move upward, a later-described sound volume adjusting section 65 increases a sound volume of the music piece as a whole output from the corresponding channel operation unit 3. As the fader operator 331 is operated to move downward, the sound volume adjusting section 65 decreases the sound volume of the music piece as a whole output from the corresponding channel operation unit 3.

Hereinbelow, the fader operator 331 of the first channel fader 33A is referred to as a first operator 33A1 and the fader operator 331 of the second channel fader 33B is referred to as a second operator 33B1. The first operator 33A1 adjusts a sound volume of the first music piece as a whole and the second operator 33B1 adjusts a sound volume of the second music piece as a whole. The first music piece is loaded on the first channel and output from the sound control device 1. The second music piece is loaded on the second channel and output from the sound control device 1.

A maximum sound volume of the first music piece as a whole is a first preset sound volume set using the first operator 33A1 and a maximum sound volume of the second music piece as a whole is a second preset sound volume set using the second operator 33B1.

Changing the sound volume of a music piece as a whole depending on a position of the fader operator 331 means that increasing or decreasing the sound volume of each of the frequency bands by amplifying each of a signal in the high-frequency band of the sound volume level set using the high-frequency band adjuster 322, a signal in the medium-frequency band of the sound volume level set using the medium-frequency band adjuster 323, and a signal in the low-frequency band of the sound volume level set using the low-frequency band adjuster 324 at a rate of amplification corresponding to the position of the fader operator 331.

The tempo slider 34 is an operator that adjusts the playback speed of the music piece by adjusting a playback beats per minute (BPM) of the music piece loaded on the corresponding channel. It should be noted that the BPM of the music piece refers to a tempo of the music piece, that is, the number of beats of the music piece per minute. An original BPM of the music piece refers to an original tempo of the music piece, that is, the number of beats of the original per minute, and the playback BPM refers to a tempo of the music piece during payback, that is, the number of beats of the music piece per minute during playback.

The tempo slider 34 of the first channel operation unit 3A, which is a first tempo slider 34A, adjusts a playback BPM of the first music piece loaded on the first channel. The tempo slider 34 of the second channel operation unit 3B, which is a second tempo slider 34B, adjusts a playback BPM of the second music piece loaded on the second channel.

### Configuration of Mode Changeover Switch

The mode changeover switch 4 is a switch for switching an operation mode of the sound control device 1. The operation mode of the sound control device 1 is switched between the normal mode and the assist mode by pressing the mode changeover switch 4.

### Configuration of Cross Fader

The cross fader 5, which includes a fader operator 51 movable right and left, adjusts a balance between a sound volume of the first music piece loaded on the first channel and a sound volume of the second music piece loaded on the second channel. In the later-described normal mode, as the fader operator 51 moves leftward, the proportion of the sound volume of the first music piece in the sound volume output from the sound control device 1 increases. As the fader operator 51 moves rightward, the proportion of the sound volume of the second music piece in the sound volume output from the sound control device 1 increases.

Hereinbelow, one of ends in an operation-possible range RC of the fader operator 51 is referred to as a first end TC1 and the other end is referred to as a second end TC2. In the exemplary embodiment, the movement direction of the fader operator 51 is a right-and-left direction, so that the first end TC1 is a left end of the operation-possible range RC and the second end TC2 is a right end of the operation-possible range RC.

In a case where the fader operator 51 is positioned at the first end TC1, the sound volume of the first music piece as a whole is the first preset sound volume and the sound volume of the second music piece is a minimum sound volume. In a case where the fader operator 51 is positioned at the second end TC2, the sound volume of the first music piece is the minimum sound volume and the sound volume of the second music piece is the second preset sound volume.

### Configuration of Controller

FIG. 2 is a block diagram of a configuration of the controller 6.

The controller 6, which includes a circuit board including at least one processor such as a central processing unit (CPU), reads a sound control program stored in a computer-readable manner in a non-illustrated storage and performs processing. That is, the processor forming the controller 6 is a computer and the controller 6 controls the operation of the sound control device 1 based on the sound control program. Specifically, the controller 6 plays the music piece loaded on each channel and adjusts a mixed state of the first music piece and the second music piece based on the operation on the cross fader 5 and the channel faders 33A, 33B.

Such a controller 6 includes a first playback section 61, a second playback section 62, a position acquiring section 63, a mode changeover section 64, the sound volume adjusting section 65, an operation determining section 66, a comparing section 67, a composition determining section 68, an effect selecting section 69, an effect adding section 70, a playback controlling section 71, a composition switching section 72, and a filter 73, as illustrated in FIG. 2. Of the above, the operation determining section 66, the comparing section 67, the composition determining section 68, the effect selecting section 69, the effect adding section 70, the playback controlling section 71, the composition switching section 72, and the filter 73 function in a case where the operation mode of the sound control device 1 is the assist mode.

The first playback section 61 plays the first music piece loaded on the first channel. Specifically, the first playback section 61 plays the first music piece at the BPM of the first music piece. The BPM of the first music piece refers to, in a case where the playback BPM of the first music piece is adjusted using the first tempo slider 34A, an adjusted playback BPM of the first music piece and refers to, in a case where the playback BPM of the first music piece is not adjusted using the first tempo slider 34A, the original BPM of the first music piece.

The second playback section 62 plays the second music piece loaded on the second channel. Specifically, the second playback section 62 plays the second music piece at the original BPM of the second music piece. The BPM of the second music piece refers to, in a case where the playback BPM of the second music piece is adjusted using the second tempo slider 34B, an adjusted playback BPM of the second music piece and refers to, in a case where the playback BPM of the second music piece is not adjusted using the second tempo slider 34B, the original BPM of the second music piece.

The position acquiring section 63 acquires a position of each operator. For instance, the position acquiring section 63 acquires a position of the fader operator 331 within an operation-possible range of each of the channel faders 33, a position of each of the tempo sliders 34 within an operation-possible range, and a position of the fader operator 51 within the operation-possible range of the cross fader 5.

For instance, the position acquiring section 63 acquires a numeral value indicating a relative position of the fader operator 51 to the first end TC1, assuming that the positioning of the fader operator 51 at the first end TC1 is represented by 0 and the positioning of the fader operator 51 at the second end TC2 is represented by 1.

The mode changeover section 64 switches, in response to an input operation on the mode changeover switch 4, the operation mode of the sound control device 1 between the normal mode and the assist mode. The normal mode, which will be described later in detail, is a mode in which the sound control device 1 provides no assistance in mixing the first music piece and the second music piece. The assist mode is a mode in which the sound control device 1 provides assistance in mixing the first music piece and the second music piece so that the music pieces are mixed without a feeling of strangeness.

### Function of Sound Volume Adjusting Section

Based on the positions of the fader operator 51 and the respective operators 33A1, 33B1 acquired by the position acquiring section 63, the sound volume adjusting section 65 adjusts the sound volume of the first music piece output from the sound control device 1 and the sound volume of the second music piece output from the sound control device 1 as well as adjusts a balance between the sound volume of the first music piece and the sound volume of the second music piece. Specifically, the sound volume adjusting section 65 adjusts the balance between the sound volume of the first music piece as a whole and the sound volume of the second music piece as a whole according to the position of the fader operator 51. In addition, the sound volume adjusting section 65 adjusts the sound volume of the first music piece according to the position of the first operator 33A1 of the first channel fader 33A and adjusts the sound volume of the second music piece according to the position of the second operator 33B1 of the second channel fader 33B.

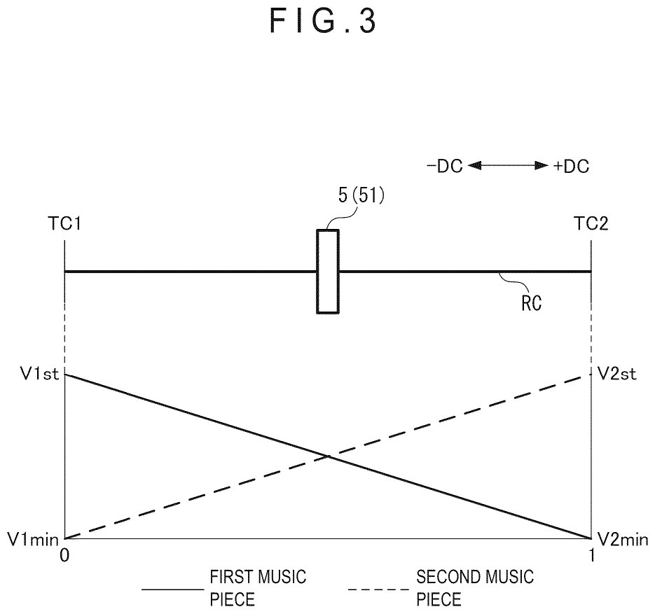

FIG. 3 illustrates a change in sound volume of the first music piece as a whole and a change in sound volume of the second music piece as a whole caused by operating the cross fader 5. The numeral values indicating relative positions of the fader operator 51, which are acquired by the position acquiring section 63, are set on the horizontal axis of a graph in FIG. 3.

Based on the position of the fader operator 51 of the cross fader 5 within the operation-possible range RC, the sound volume adjusting section 65 adjusts the balance between the sound volume of the first music piece as a whole and the sound volume of the second music piece as a whole. The sound volume of the first music piece as a whole refers to all of a sound volume in the high-frequency band, a sound volume in the medium-frequency band, and a sound volume in the low-frequency band of the first music piece. A maximum value of the sound volume of the first music piece as a whole is a first preset sound volume V1st set using the first operator 33A1. The balance between the high-frequency band, the medium-frequency band, and the low-frequency band of the first music piece corresponds to a ratio of the volume levels set by the respective adjuster 322 to 324 of the first channel operation unit 3A. The same applies to the sound volume of the second music piece as a whole; a maximum value of the sound volume of the second music piece as a whole is a second preset sound volume V2st set using the second operator 33B1. The balance between the high-frequency band, the medium-frequency band, and the low-frequency band of the second music piece corresponds to a ratio of the volume levels set by the respective adjuster 322 to 324 of the second channel operation unit 3B.

A direction from the first end TC1 toward the second end TC2 is referred to as +DC direction and a direction from the second end TC2 toward the first end TC1 is referred to as −DC direction.

Specifically, in a case where the fader operator 51 is positioned at the first end TC1, the sound volume adjusting section 65 sets the sound volume of the first music piece as a whole at the above-described first preset sound volume V1st and the sound volume of the second music piece as a whole at a second minimum sound volume V2min, as illustrated in FIG. 3.

In a case where the fader operator 51 is positioned at the second end TC2, the sound volume adjusting section 65 sets the sound volume of the first music piece as a whole at a first minimum sound volume V1min and the sound volume of the second music piece as a whole at the above-described second preset sound volume V2st.

As the fader operator 51 is operated to move in the +DC direction from the first end TC1, the sound volume adjusting section 65 decreases the sound volume of the first music piece as a whole from the first preset sound volume V1st and increases the sound volume of the second music piece as a whole from the second minimum sound volume V2min. In other words, as the fader operator 51 is operated to move in the −DC direction from the second end TC2, the sound volume adjusting section 65 increases the sound volume of the first music piece as a whole from the first minimum sound volume V1min and decreases the sound volume of the second music piece as a whole from the second preset sound volume V2st.

That is, as the fader operator 51 is operated to move in the +DC direction, the proportion of the second music piece to the sound volume output from the sound control device 1 increases. As the fader operator 51 is operated to move in the −DC direction, the proportion of the first music piece to the sound volume output from the sound control device 1 increases.

As seen from the above, the sound volume of the first music piece as a whole and the sound volume of the second music piece as a whole are adjusted according to the position of the fader operator 51 within the operation-possible range RC and, consequently, the balance between the sound volume of the first music piece as a whole and the sound volume of the second music piece as a whole is adjusted. Then, the music piece to be output is switched from the first music piece to the second music piece by moving the fader operator 51 from the first end TC1 to the second end TC2. The music piece to be output is switched from the second music piece to the first music piece by moving the fader operator 51 from the second end TC2 to the first end TC1.

### Configurations of Operation Determining Section, Comparing Section, and Composition Determining Section

The operation determining section 66 determines, based on the position of the fader operator 51 acquired by the position acquiring section 63, whether or not the fader operator 51 has been operated to move from one of the first end TC1 and the second end TC2. Determining that the fader operator 51 has been operated to move from one of the ends, the operation determining section 66 determines whether or not the fader operator 51 has reached the other end within a predetermined period of time.

The comparing section 67 compares the BPM of the first music piece and the BPM of the second music piece. Specifically, the comparing section 67 determines whether or not a difference between the BPM of the first music piece and the BPM of the second music piece is larger than a predetermined value.

The composition determining section 68 determines whether or not there is a vocal part in each of the first music piece and the second music piece. Whether or not there is a vocal part in a music piece may be determined by reference to a music piece database from the title of the music piece or by analyzing the composition of the music piece.

### Configurations of Effect Selecting Section and Effect Adding Section

The effect selecting section 69 selects, based on a result of the comparison between the BPM of the first music piece and the BPM of the second music piece performed by the comparing section 67, a sound effect to be added to at least one of the first music piece or the second music piece. The sound effect is a so-called Effect (Fx) and includes, for instance, a sync (synchronization) effect that is synched with BPM and an async (asynchronous) effect that is not synched with the BPM. Examples of the sync effect include Delay, Echo, Flanger, and Phaser. Examples of the async effect include a space effect. Examples of the async effect include Reverb.

Specifically, in a case where the difference between the BPM of the first music piece and the BPM of the second music piece is equal to or less than the predetermined value, the effect selecting section 69 selects at least one of the above-described sync effects. In a case where the difference between the BPM of the first music piece and the BPM of the second music piece is larger than the predetermined value, the effect selecting section 69 selects at least one of the above-described async effects.

In response to the necessity of adding a sound effect, the effect adding section 70 adds the sound effect to at least one of the first music piece or the second music piece. For instance, the effect adding section 70 adds the sound effect selected by the effect selecting section 69 to at least one of the first music piece or the second music piece.

### Configuration of Playback Controlling Section

The playback controlling section 71 controls a playback state of each of the music pieces played by the corresponding one of the playback sections 61 and 62. For instance, the playback controlling section 71 moves a playback position of the first music piece and a playback position of the second music piece. More particularly, in a case where the operation determining section 66 determines that the fader operator 51 has been moved from one of the first end TC1 and the second end TC2 to the other end within the predetermined period of time, the playback controlling section 71 moves the playback position of the music piece of a channel corresponding to the other end to a predetermined position. Although the predetermined position is a start position of Drop, which is a hook-line, in the exemplary embodiment, the predetermined position may be any other position and may be set by a user.

### Configurations of Composition Switching Section and Filter

The composition switching section 72 performs switching between a part(s) included in the first music piece and a part(s) included in the second music piece. Specifically, in the switching between the first music piece and the second music piece, the composition switching section 72 performs switching between a vocal part included in the first music piece and a vocal part included in the second music piece depending on the position of the fader operator 51. The vocal part included in the first music piece corresponds to a first vocal part and the vocal part included in the second music piece corresponds to a second vocal part.

When switching the music piece to be output from one of the first music piece and the second music piece to the other, the filter 73 removes a low-frequency component in the one music piece. Specifically, the filter 73 removes a bass drum sound from the one music piece.

### Mixing Assist Process Performed in Assist Mode

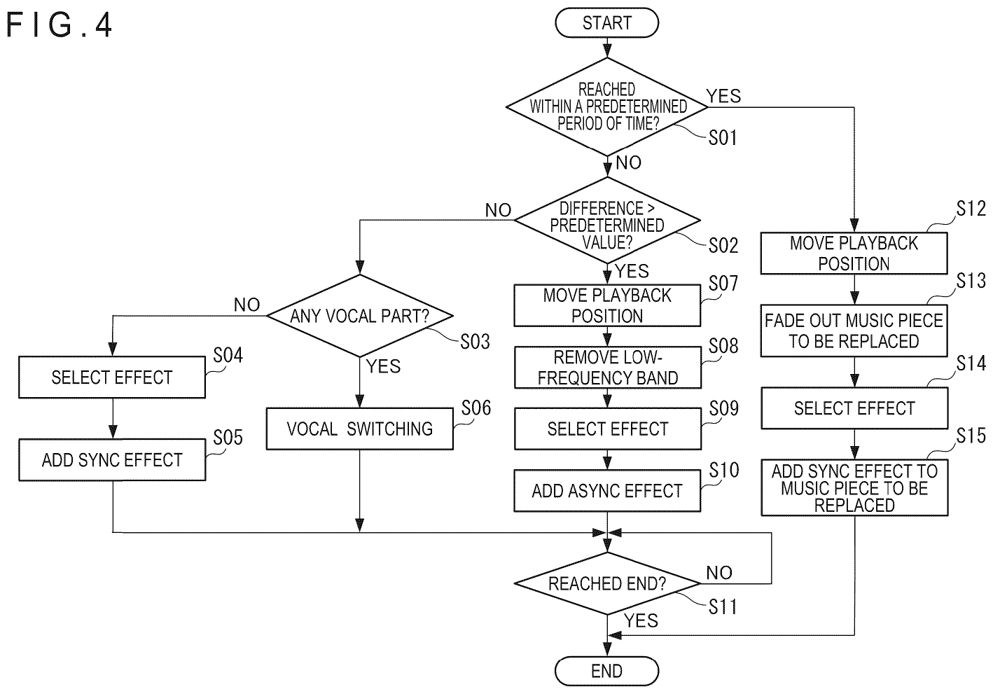

FIG. 4 is a flowchart for a mixing assist process performed by the controller 6 in the assist mode.

When the operation mode of the sound control device 1 is the assist mode and the fader operator 51 positioned at one of the first end TC1 and the second end TC2 is operated to move toward the other end, the controller 6 reads the sound control program stored in the non-illustrated storage and performs the mixing assist process below. That is, when the operation mode of the sound control device 1 is the assist mode and an operation to decrease the sound volume of one of the first music piece and the second music piece and increase the sound volume of the other music piece is performed, the controller 6 performs the mixing assist process below.

The following describes a case where the one end is the first end TC1, the other end is the second end TC2, and the fader operator 51 positioned at the first end TC1 is operated to move in the +DC direction. It should be noted that the same applies to a case where the one end is the second end TC2, the other end is the first end TC1, and the fader operator 51 positioned at the second end TC2 is operated to move in the −DC direction. As described above, when the fader operator 51 is positioned at the first end TC1, the sound volume of the first music piece, which is the music piece of the first channel, becomes the first preset sound volume V1st and the sound volume of the second music piece, which is the music piece of the second channel, becomes the second minimum sound volume V2min. When the fader operator 51 is positioned at the second end TC2, the sound volume of the second music piece becomes the second preset sound volume V2st and the sound volume of the first music piece becomes the first minimum sound volume V1min.

In the mixing assist process, the operation determining section 66 first determines whether or not the fader operator 51 has reached the second end TC2 within a predetermined period of time after being operated to move from the first end TC1 (Step S01), as illustrated in FIG. 4.

If the operation determining section 66 determines in the determination process in Step S01 that the fader operator 51 has not reached the second end TC2 within the predetermined period of time (Step S01: NO), the comparing section 67 compares the BPM of the first music piece and the BPM of the second music piece and determines whether or not the difference in BPM between the respective music pieces is larger than a predetermined value (Step S02).

If the comparing section 67 determines in the determination process in Step S02 that the difference in BPM is not larger than the predetermined value, i.e., equal to or less than the predetermined value (Step S02: NO), the composition determining section 68 determines whether or not a vocal part is included in each of the first music piece and the second music piece (Step S03).

If the composition determining section 68 determines in the determination process in Step S03 that no vocal part is included in at least one of the first music piece or the second music piece (Step S03: NO), the effect selecting section 69 selects a sound effect corresponding to a result of the comparison between the BPM of the first music piece and the BPM of the second music piece, i.e., the above-described difference in BPM (Step S04). Here, since the difference in BPM is equal to or less than the predetermined value, the effect selecting section 69 determines that the BPM of the first music piece and the BPM of the second music piece are close to each other and selects one of the above-described sync effects.

If the sound effect is selected in Step S04, the effect adding section 70 adds the selected sound effect to at least one of the first music piece or the second music piece (Step S05). Here, the effect adding section 70 may add a sync effect that is synched with the BPM of the first music piece to the first music piece and add a sync effect that is synched with the BPM of the second music piece to the second music piece. Further, the effect adding section 70 may add a sync effect that is synched with the BPM of one of the first music piece and the second music piece to each of the first music piece and the second music piece. Further, the effect adding section 70 may add, to one of the first music piece and the second music piece, a sync effect that is synched with the one music piece and add, to the other music piece, the sync effect that is synched with the one music piece.

After Step S04, the controller 6 proceeds to processing in Step S11.

If the composition determining section 68 determines in the determination process in Step S03 that a vocal part is present in each of the first music piece and the second music piece in the determination process in Step S03 (Step S03: YES), the composition switching section 72 performs switching between the vocal part of the first music piece and the vocal part of the second music piece depending on the position of the fader operator 51 (Step S06).

After Step S06, the controller 6 proceeds to processing in Step S11.

If the comparing section 67 determines in the determination process in Step S02 that the difference in BPM is larger than the predetermined value (Step S02: YES), the playback controlling section 71 moves the playback position of the second music piece, which is a target music piece to be replaced from the first music piece (hereinafter also referred to as a replacement target music piece), to a predetermined position (Step S07). As described above, the playback controlling section 71 moves the playback position of the second music piece to a start position of Drop of the second music piece in the exemplary embodiment.

Further, the filter 73 removes the low-frequency band of the first music piece, which is a music piece to be replaced with the second music piece (Step S08). More particularly, the filter 73 removes a bass drum sound from the first music piece.

In addition to Steps S07 and S08, the effect selecting section 69 selects a sound effect corresponding to a result of the comparison between the BPM of the first music piece and the BPM of the second music piece (Step S09). Here, since the difference in BPM is larger than the predetermined value, the effect selecting section 69 determines that the BPM of the first music piece and the BPM of the second music piece are not close to each other and selects one of the above-described async effects. The effect selecting section 69 selects, for instance, Reverb.

The effect adding section 70 then adds the sound effect selected by the effect selecting section 69 to at least one of the first music piece or the second music piece (Step S10). Here, the effect adding section 70 adds the selected sound effect to each of the music pieces.

After Step S10, the controller 6 proceeds to processing in Step S11.

In Step S11, the operation determining section 66 determines whether or not the fader operator 51 operated to move in the +DC direction has reached the second end TC2 (Step S11).

If the operation determining section 66 determines in the determination process in Step S11 that the fader operator 51 has not reached the second end TC2, Step S11 is repeatedly performed with a current state being maintained. That is, for instance, the sound effect added to the music piece is maintained until the fader operator 51 reaches the second end TC2.

If the operation determining section 66 determines in the determination process in Step S11 that the fader operator 51 has reached the second end TC2, the controller 6 terminates the mixing assist process.

If the operation determining section 66 determines in the determination process in Step S01 that the fader operator 51 has reached the second end TC2 from the first end TC1 within the predetermined period of time (Step S01: YES), the playback controlling section 71 moves the playback position of the second music piece to the above-described predetermined position, that is, the Drop start position (Step S12)

Further, the playback controlling section 71 fades out the first music piece, which is the music piece to be replaced (Step S13). That is, the playback controlling section 71 causes the sound volume adjusting section 65 to gradually decrease the sound volume of the first music piece as a whole. At this time, the playback controlling section 71 may move the playback position of the first music piece to the outro of the first music piece.

Moreover, the effect selecting section 69 selects a sync effect to be added to the first music piece (Step S14) and the effect adding section 70 adds the selected sync effect to the first music piece (Step S15). At this time, the effect adding section 70 adds the selected sync effect to the first music piece in conjunction with the BPM of the second music piece, which is the replacement target music piece.

After that, the controller 6 terminates the mixing assist process.

### Utility of Assist Mode

In the above-described assist mode, a sound effect is added to at least one of the music pieces or switching between vocal parts is performed, in response to the operation on the fader operator 51 to adjust the sound volume of the first music piece as a whole and the sound volume of the second music piece as a whole and to perform switching of the music piece to be output from the sound control device 1, when the fader operator 51 is positioned at the first end TC1 or the second end TC2, between the first music piece and the second music piece. At this time, a sound effect (one of a sync effect and an async effect) is added to the music piece according to the difference in BPM between the respective music pieces, which makes it possible to mix the first music piece and the second music piece regardless of the BPM of the first music piece and the BPM of the second music piece. This allows a user to seamlessly mix the first music piece and the second music piece without having to operate the tempo slider 34 to manually align the BPMs of the respective music pieces.

In addition, in a case where the difference in BPM between the first music piece and the second music piece is larger than the predetermined value and the first music piece is to be slowly connected to the second music piece so that the time for switching from the first music piece to the second music piece exceeds a predetermined time, the bass drum sound of the first music piece is removed. This makes it possible to play the first music piece with a sense of rhythm removed. It is thus possible to connect the first music piece to the second music piece having a large difference in BPM from the first music piece without the occurrence of a rapid change in rhythm.

Further, in a case where the fader operator 51 positioned at one of the first end TC1 and the second end TC2 is moved to the other end within the predetermined period of time, the playback position of the replacement target music piece, which is replaced from the music piece to be replaced, is moved and the music piece to be replaced is faded out while a sync effect is synched with the BPM of the replacement target music piece is added to the music piece to be replaced. This makes it possible to reduce impairment of the rhythm of the second music piece with a reverberant sound of the first music piece left. Accordingly, the first music piece and the second music piece can be mixed instantly without a feeling of strangeness.

### Effects of Exemplary Embodiment

The sound control device 1 according to the exemplary embodiment described above produces the following effects.

The sound control device 1 mixes the first music piece and the second music piece. The sound control device 1 includes the comparing section 67 and the effect selecting section 69. The comparing section 67 compares the BPM of the first music piece and the BPM of the second music piece. The effect selecting section 69 selects a sound effect according to a result of the comparison by the comparing section 67.

In such a configuration, the sound effect corresponding to the result of the comparison between the BPM of the first music piece and the BPM of the second music piece is selected, which makes it possible to add, to at least one of the first music piece or the second music piece, the sound effect corresponding to the difference in BPM between the respective music pieces in mixing the first music piece and the second music piece. This allows a user such as a beginner who is unfamiliar with operating the sound control device to mix the first music piece and the second music piece without a feeling of strangeness.

In the sound control device 1, in a case where the difference between the BPM of the first music piece and the BPM of the second music piece is equal to or less than the predetermined value, the effect selecting section 69 selects a sync effect that is synched with the BPM, from among the above-described sound effects.

In such a configuration, the sync effect is selected in a case where the difference in BPM between the respective music pieces is equal to or less than the predetermined value, which makes it possible to add the sound effect that is synched with the BPM of the first music piece and the BPM of the second music piece to at least one of the music pieces. Thus, the first music piece and the second music piece can be mixed without a feeling of strangeness.

In the sound control device 1, in a case where the difference between the BPM of the first music piece and the BPM of the second music piece is larger than the predetermined value, the effect selecting section 69 selects an async effect that is not synched with the BPM, from among the sound effects.

In such a configuration, the selected async effect is added to at least one of the first music piece or the second music piece, which makes it possible to mix the first music piece and the second music piece without feeling the difference in BPM between the respective music pieces. The first music piece and the second music piece can thus be mixed without a feeling of strangeness.

The sound control device 1 includes the effect adding section 70 that adds the sound effect selected by the effect selecting section 69 to at least one of the first music piece or the second music piece in response to the operation on the fader operator 51. The operation on the fader operator 51 includes an operation to adjust a balance between the sound volume of the first music piece and the sound volume of the second music piece.

In such a configuration, the effect adding section 70 adds the selected sound effect to the at least one music piece in response to, as a trigger, an operation to perform switching from the first music piece to the second music piece or an operation to perform switching from the second music piece to the first music piece. This makes it possible to add the sound effect in accordance with the operation for switching the music piece. Accordingly, the first music piece and the second music piece can be mixed without a feeling of strangeness.

The sound control device 1 mixes the first music piece and the second music piece. The sound control device 1 includes the playback controlling section 71 and the effect adding section 70. The playback controlling section 71 fades out the first music piece when an operation to switch the music piece to be output from the sound control device 1 from the first music piece to the second music piece is completed within a predetermined period of time since the start of that switching operation. The first music piece is faded out, for instance, when the fader operator 51 positioned at the first end TC1 is operated to move toward the second end TC2 and then reaches the second end TC2 within the predetermined period of time. The effect adding section 70 adds, out of the sound effects, a sync effect that is synched with the BPM of the second music piece to the first music piece.

Consider a case where the BPM of the first music piece is different from the BPM of the second music piece. If a sync effect corresponding to the BPM of the first music piece is added to the first music piece when the first music piece is faded out during the switching from the first music piece to second music piece, a feeling of strangeness may occur from the difference in BPM between the music pieces.

In this regard, in the above-described configuration, the sync effect that is synched with the BPM of the second music piece is added to the fading first music piece, which makes it possible to reduce the occurrence of a feeling of strangeness attributed to the difference in BPM even in a case where the fading first music piece and the second music piece are output. Accordingly, the first music piece can be switched to the second music piece without a feeling of strangeness.

In the sound control device 1, the playback controlling section 71 moves the playback position of the second music piece to a predetermined position set in advance in the second music piece, when the above-described switching operation is completed within the predetermined period of time.

Such a configuration makes it possible to play the second music piece from the predetermined position set in advance, when the second music piece is switched from the first music piece. For instance, the second music piece can be played from Drop of the second music piece by performing the above-described switching operation after the completion of the playback of Drop, which is a hook-line, of the first music piece. Accordingly, the first music piece can be switched to the second music piece without a feeling of strangeness.

The sound control device 1 mixes the first music piece and the second music piece. The first music piece includes the first vocal part and the second music piece includes the second vocal part. The sound control device 1 includes the composition switching section 72. In response to an operation to decrease the sound volume of the first music piece and increase the sound volume of the second music piece at a speed equal to or less than a predetermined speed, the composition switching section 72 performs switching between the first vocal part of the first music piece and the second vocal part of the second music piece in a case where the difference between the BPM of the first music piece and the BPM of the second music piece is equal to or less than the predetermined value.

Such a configuration makes it possible to continuously output the second vocal part during switching from the first music piece to the second music piece, for instance, until the switching operation is completed. Thus, it is possible to reduce the occurrence of a feeling of strangeness attributed to the difference in vocal part during switching from the first music piece to the second music piece.

The computer-readable sound control program that causes a computer to function as the sound control device 1 is recorded in the storage of the sound control device 1. At least one processor forming the controller 6 reads the sound control program and causes the sound control device 1 to function.

The sound control device 1 produces the above-described effects by causing at least one processor to read and execute such a sound control program.

### Modifications of Exemplary Embodiment

The invention is not limited to the above exemplary embodiment, and modifications, improvements, and the like are within the scope of the invention, insofar as the object of the invention is achievable.

In the above-described exemplary embodiment, the effect selecting section 69 selects a sync effect in a case where a difference between the BPM of the first music piece and the BPM of the second music piece is equal to or less than the predetermined value, and selects an async effect in a case where the difference is larger than the predetermined value. The invention, however, is not limited thereto. The effect selecting section 69 may select a sync effect in a case where the BPM of the first music piece is the same as the BPM of the second music piece and select an async effect in a case where the BPM of the first music piece is different from the BPM of the second music piece.

Moreover, in a case where the difference in BPM between the respective music pieces is larger than the predetermined value, a sound effect to be selected in a case where the BPMs of the respective music pieces are larger than a predetermined threshold may be different from a sound effect to be selected in a case where the BPMs of the respective music pieces are equal to or less than the predetermined threshold.

In the above-described exemplary embodiment, the effect adding section 70 adds the sound effect selected by the effect selecting section 69 to a music piece. The effect adding section 70 may add the sound effect in response to a user operation on an operator other than the fader operator 51. For instance, the effect adding section 70 may add the sound effect at a timing when a predetermined button is pressed.

In the above-described exemplary embodiment, when the switching operation to switch a music piece to be output from one of the first music piece and the second music piece to the other music piece is completed within the predetermined period of time since the start of that switching operation, the playback controlling section 71 fades out the one music piece. For instance, in a case where the switching operation to perform switching from one of the music pieces to the other music piece is instantly performed, the one music piece is faded out. The invention, however, is not limited thereto, and the one music piece may not be caused to fade out.

Further, the effect adding section 70 adds a sync effect to one of the music pieces. More particularly, the effect adding section 70 adds, to one of the music pieces, a sync effect that is synched with the BPM of the other of the music pieces. However, the invention is not limited thereto. A sync effect that is synched with the BPM of the one music piece may be added, an async effect may be added, or no sound effect may be added.

In the above-described exemplary embodiment, in response to the operation to decrease the sound volume of the first music piece and increase the sound volume of the second music piece at a speed equal to or less than the predetermined speed, the composition switching section 72 performs switching between the first vocal part and the second vocal part in a case where a difference between the BPM of the first music piece and the BPM of the second music piece is equal to or less than the predetermined value. The invention, however, is not limited thereto, and the switching of the vocal part may not be performed.

In the above-described exemplary embodiment, an operator that receives the operation to adjust a balance between the sound volume of the first music piece and the sound volume of the second music piece, the switching operation to switch a music piece to be output from the first music piece to the second music piece, and the operation to adjust the sound volume of the first music piece and the sound volume of the second music piece is exemplified by the fader operator 51 of the cross fader 5. The invention, however, is not limited thereto, and the operator may be any other operator. The operator may be, for instance, a channel fader. In addition, the operator that receives the above-described operations may not be a slidable operator, but may be, for instance, an operation knob that rotates around a rotation axis.

In the above-described exemplary embodiment, the sound control program to be read and executed by an arithmetic processing circuit, which is a computer, is stored in the non-illustrated storage. The invention, however, is not limited thereto, and the sound control program may be recorded in a computer-readable manner in a recording medium and read from the recording medium and executed at the time of operating the sound control device 1.

In addition, the sound control program may be provided from a provider device such as a server through a network such as the Internet.

### Overview of the Invention

The overview of the invention is appended below.

[1] A sound control device is configured to mix a first music piece and a second music piece and includes: a comparing section configured to compare a BPM of the first music piece and a BPM of the second music piece; and an effect selecting section configured to select a sound effect according to a result of the comparison. In such a configuration, the sound effect corresponding to the result of the comparison between the BPM of the first music piece and the BPM of the second music piece is selected, which makes it possible to add, to at least one of the first music piece or the second music piece, the sound effect corresponding to the difference in BPM between the respective music pieces in mixing the first music piece and the second music piece. This allows a user such as a beginner who is unfamiliar with operating the sound control device to mix the first music piece and the second music piece without a feeling of strangeness.

[2] In the sound control device according to [1], in which in a case where a difference between the BPM of the first music piece and the BPM of the second music piece is equal to or less than a predetermined value, the effect selecting section is configured to select a sync effect that is synched with the BPM from among a plurality of the sound effects.

In such a configuration, the sync effect is selected in a case where the BPM of the respective music pieces is the same, which makes it possible to add the sound effect that is synched with the BPM of the first music piece and the BPM of the second music piece to at least one of the music pieces. Thus, the first music piece and the second music piece can be mixed without a feeling of strangeness.

[3] In the sound control device according to [1] or [2], in which in a case where a difference between the BPM of the first music piece and the BPM of the second music piece is larger than a predetermined value, the effect selecting section is configured to select an async effect that is not synched with the BPM from among a plurality of the sound effects.

In such a configuration, the async effect is selected in a case where the BPMs of the respective music pieces are different from each other. The selected async effect is added to at least one of the music pieces, which makes it possible to mix the first music piece and the second music piece without feeling the difference in BPM between the respective music pieces. Thus, the first music piece and the second music piece can be mixed without a feeling of strangeness.

[4] The sound control device according to any one of [1] to [3] includes an effect adding section configured to add the sound effect selected by the effect selecting section to at least one of the first music piece or the second music piece in response to an operation to adjust a balance between a sound volume of the first music piece and a sound volume of the second music piece.

In such a configuration, the effect adding section adds the selected sound effect to at least one of the music pieces in response to, as a trigger, an operation to perform switching from the first music piece to the second music piece or an operation to perform switching from the second music piece to the first music piece. This makes it possible to add the sound effect in accordance with the operation for switching the music piece. Accordingly, the first music piece and the second music piece can be mixed without a feeling of strangeness.

[5] A sound control device is configured to mix a first music piece and a second music piece and includes: a playback controlling section configured to fade out the first music piece when a switching operation to switch a music piece to be output from the first music piece to the second music piece is completed within a predetermined period of time since the switching operation is started; and an effect adding section configured to add, out of at least one sound effect, a sync effect that is synched with a BPM of the second music piece to the first music piece.

Consider a case where the BPM of the first music piece is different from the BPM of the second music piece. If a sync effect corresponding to the BPM of the first music piece is added to the first music piece when the first music piece is faded out during the switching from the first music piece to second music piece, a feeling of strangeness may occur from the difference in BPM between the music pieces.

In this regard, in the above-described configuration, the sync effect that is synched with the BPM of the second music piece is added to the fading first music piece, which makes it possible to reduce the occurrence of a feeling of strangeness attributed to the difference in BPM even in a case where the fading first music piece and the second music piece are output. Accordingly, the first music piece can be switched to the second music piece without a feeling of strangeness.

[6] In the sound control device according to [5], in which the playback controlling section is configured to move a playback position of the second music piece to a position set in advance in the second music piece, when the switching operation is completed within the predetermined period of time.

Such a configuration makes it possible to play the second music piece from the position set in advance, when the second music piece is switched from the first music piece. For instance, the second music piece can be played from Drop of the second music piece by performing the above-described switching operation after the completion of the playback of Drop, which is a hook-line, of the first music piece. Accordingly, the first music piece can be switched to the second music piece without a feeling of strangeness.

[7] A sound control device is configured to mix a first music piece and a second music piece, the first music piece including a first vocal part, the second music piece including a second vocal part, and the sound control device includes a composition switching section configured to perform, in response to an operation to decrease a sound volume of the first music piece and increase a sound volume of the second music piece at a speed equal to or less than a predetermined speed, switching between the first vocal part and the second vocal part in a case where a difference between a BPM of the first music piece and a BPM of the second music piece is equal to or less than a predetermined value.

Such a configuration makes it possible to continuously output the second vocal part during switching from the first music piece to the second music piece, for instance, until the switching operation is completed. Thus, it is possible to reduce the occurrence of a feeling of strangeness attributed to the difference in vocal part during switching from the first music piece to the second music piece.

[8] A sound control program is configured to be recorded in a computer-readable manner and cause a computer to function as the sound control device according to any one of [1] to [7].

Causing the computer to execute such a sound control program produces the effects similar to those of the above-described sound control device.

### EXPLANATION OF CODES

1 . . . sound control device, 33A . . . first channel fader, 33A1 . . . first operator, 33B . . . second channel fader, 33B1 . . . second operator, 5 . . . cross fader, 51 . . . fader operator, 6 . . . controller, 67 . . . comparing section, 68 . . . composition determining section, 69 . . . effect selecting section, 70 . . . effect adding section, 71 . . . playback controlling section, 72 . . . composition switching section, 73 . . . filter.

1. A sound control device configured to mix a first music piece and a second music piece, comprising:
a comparing section configured to compare a BPM of the first music piece and a BPM of the second music piece; and
an effect selecting section configured to select a sound effect according to a result of the comparison.

2. The sound control device according to claim 1, wherein
in a case where a difference between the BPM of the first music piece and the BPM of the second music piece is equal to or less than a predetermined value, the effect selecting section is configured to select a synchronization effect that is synched with the BPM from among a plurality of the sound effects.

3. The sound control device according to claim 1, wherein
in a case where a difference between the BPM of the first music piece and the BPM of the second music piece is larger than a predetermined value, the effect selecting section is configured to select an asynchronous effect that is not synched with the BPM from among a plurality of the sound effects.

4. The sound control device according to claim 1, further comprising an effect adding section configured to add the sound effect selected by the effect selecting section to at least one of the first music piece or the second music piece in response to an operation to adjust a balance between a sound volume of the first music piece and a sound volume of the second music piece.

5. A sound control device configured to mix a first music piece and a second music piece, comprising:
a playback controlling section configured to fade out the first music piece when a switching operation to switch a music piece to be output from the first music piece to the second music piece is completed within a predetermined period of time since the switching operation is started; and
an effect adding section configured to add, out of at least one sound effect, a synchronization effect that is synched with a BPM of the second music piece to the first music piece.

6. The sound control device according to claim 5, wherein
the playback controlling section is configured to move a playback position of the second music piece to a position set in advance in the second music piece, when the switching operation is completed within the predetermined period of time.

7. A sound control device configured to mix a first music piece and a second music piece, the first music piece comprising a first vocal part, the second music piece comprising a second vocal part,
the sound control device comprising a composition switching section configured to perform, in response to an operation to decrease a sound volume of the first music piece and increase a sound volume of the second music piece at a speed equal to or less than a predetermined speed, switching between the first vocal part and the second vocal part in a case where a difference between a BPM of the first music piece and a BPM of the second music piece is equal to or less than a predetermined value.

8. A non-transitory computer-readable storage medium storing a sound control program configured to cause a computer to function as the sound control device according to claim 1.

9. A non-transitory computer-readable storage medium storing a sound control program configured to cause a computer to function as the sound control device according to claim 5.

10. A non-transitory computer-readable storage medium storing a sound control program configured to cause a computer to function as the sound control device according to claim 7.
